(19) United States
(12) Patent Application Publication
(10) Pub. No.: US 2016/0288352 A1
(43) Pub. Date: Oct. 6, 2016

(54) KNIFE HAVING REMOVABLE BLADE GUARD

(71) Applicant: Milwaukee Electric Tool Corporation, Brookfield, WI (US)

(72) Inventors: Grant T. Squiers, Cudahy, WI (US); Andrew G. Wagner, Lisbon, WI (US); Matthew W. Naiva, Wauwatosa, WI (US); Derek Rose, Waukesha, WI (US)

(21) Appl. No.: 15/088,684

(22) Filed: Apr. 1, 2016

Related U.S. Application Data
(60) Provisional application No. 62/141,946, filed on Apr. 2, 2015.

(51) Int. Cl. B26B 29/02; B26B 3/00

(52) U.S. Cl. CPC B26B 29/025; B26B 3/00

(57) ABSTRACT

A knife having a handle, a blade, and a guard. The handle includes a first detent on a first sidewall adjacent a front end of the handle and a second detent on a second sidewall adjacent the front end. The blade extends from the front end of the handle. The guard includes a first detent inside the guard on a first side wall adjacent an aperture of the guard and a second detent inside the guard on a second sidewall adjacent the aperture. The first detent of the handle engages the first detent of the guard and the second detent of the handle engages the second detent of the guard to removably couple the handle and the guard.

### CROSS-REFERENCE TO RELATED APPLICATIONS

This application claims priority to U.S. Provisional Patent Application No. 62/141,946, filed Apr. 2, 2015, the entire contents of which are hereby incorporated by reference herein.

### BACKGROUND

The present invention relates to knives, and in particular, to knives having removable blade guards. Knives typically include a handle and a blade. The blade can either be pivotally connected to the handle or fixed relative to the handle. When the blade is pivotally connected to the handle, the blade pivots into the handle for storage. When the blade is fixed to the handle, the blade cannot pivot into the handle for storage. Therefore, fixed blade knives often include a removable blade guard that receives the blade. The blade guard protects the blade when not in use. Users desire a blade guard that is both easy to remove but yet is held firmly in place to minimize the risk of the guard inadvertently sliding off the blade.

### SUMMARY

The present invention provides, in one aspect, a knife including a handle having a top wall, a bottom wall, a first side wall that extends from the top wall to the bottom wall, a second side wall that extends from the top wall to the bottom wall opposite the first side wall, a front end, a back end opposite the front end, a longitudinal axis that extends centrally through the handle through the front end and the back end, a first detent on the first sidewall adjacent the front end, and a second detent on the second sidewall adjacent the front end. The knife further includes a blade that extends from the front end of the handle along the longitudinal axis and a guard formed from a flexible elastic material. The guard includes a top wall, a bottom wall, a first side wall that extends from the top wall to the bottom wall, a second side wall that extends from the top wall to the bottom wall opposite the first side wall, a first end, a second end, an aperture at the first end of the guard, a first detent inside the guard on the first side wall adjacent the aperture, and a second detent inside the guard on the second sidewall adjacent the aperture. A guard width is defined as a distance between the first and second detents of the guard normal to the longitudinal axis. A handle width is defined as a distance between the first and second detents of the handle normal to the longitudinal axis. The handle width is greater than the guard width when the guard is not attached to the handle. The first detent of the handle engages the first detent of the guard and the second detent of the handle engages the second detent of the guard to removably couple the handle and the guard.

In another aspect, the invention provides a knife having a handle including a first side wall, a second side wall opposite the first side wall, a front end, a back end opposite the front end, a first detent on the first sidewall, and a second detent on the second sidewall. A blade extends from the handle. The knife further includes a guard formed from a flexible elastic material. The guard includes a first side wall, a second side, a first end, a second end, an aperture at the first end of the guard, a first detent inside the guard on the first side wall adjacent the aperture, a second detent inside the guard on the second sidewall adjacent the aperture. The first detent of the handle engages the first detent of the guard and the second detent of the handle engages the second detent of the guard to removably couple the handle and the guard. A guard width is defined as a distance between the first and second detents of the guard normal to the longitudinal axis. The flexible elastic material of the guard allows the distance to increase while the guard is coupled to the handle with the first detent of the handle engaging the first detent of the guard and the second detent of the handle engaging the second detent of the guard.

In another aspect, the invention provides a knife having a handle including a top wall, a bottom wall, a first side wall that extends from the top wall to the bottom wall, a second side wall that extends from the top wall to the bottom wall opposite the first side wall, a front end, a back end opposite the front end, a longitudinal axis that extends centrally through the handle through the front end and the back end, a first detent on the first sidewall adjacent the front end, and a second detent on the second sidewall adjacent the front end. A blade extends from the front end of the handle along the longitudinal axis. The knife further includes a guard including a top wall, a bottom wall, a first side wall that extends from the top wall to the bottom wall, a second side wall that extends from the top wall to the bottom wall opposite the first side wall, a first end, a second end, an aperture at the first end of the guard, a first detent inside the guard on the first side wall adjacent the aperture, and a second detent inside the guard on the second sidewall adjacent the aperture. The first detent of the handle engages the first detent of the guard and the second detent of the handle engages the second detent of the guard to removably couple the handle and the guard.

Other aspects of the invention will become apparent by consideration of the detailed description and accompanying drawings.

### BRIEF DESCRIPTION OF THE DRAWINGS

FIG. 1 is a perspective view of a knife and guard in accordance with an embodiment of the invention, with the guard coupled to a handle.

FIG. 2 is a perspective view of the knife of FIG. 1 with the guard removed.

FIG. 3 is a partially exploded and enlarged view of the knife and guard of FIG. 1, illustrating a left side of the knife and guard.

FIG. 4 is a partially exploded and enlarged view of the knife and guard of FIG. 1, illustrating a right side of the knife and guard.

FIG. 5 is a front side view of the knife of FIG. 1 with the guard removed.

FIG. 6 is an end view of the guard of FIG. 1.

FIG. 7 is an enlarged top side view of the knife of FIG. 1 with the guard removed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

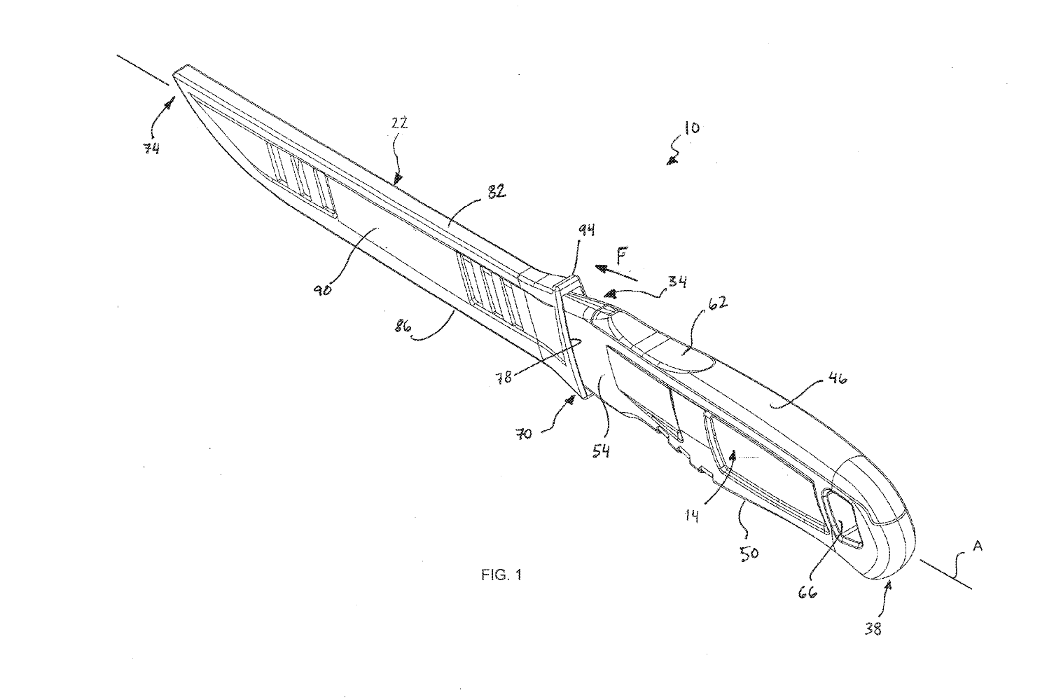

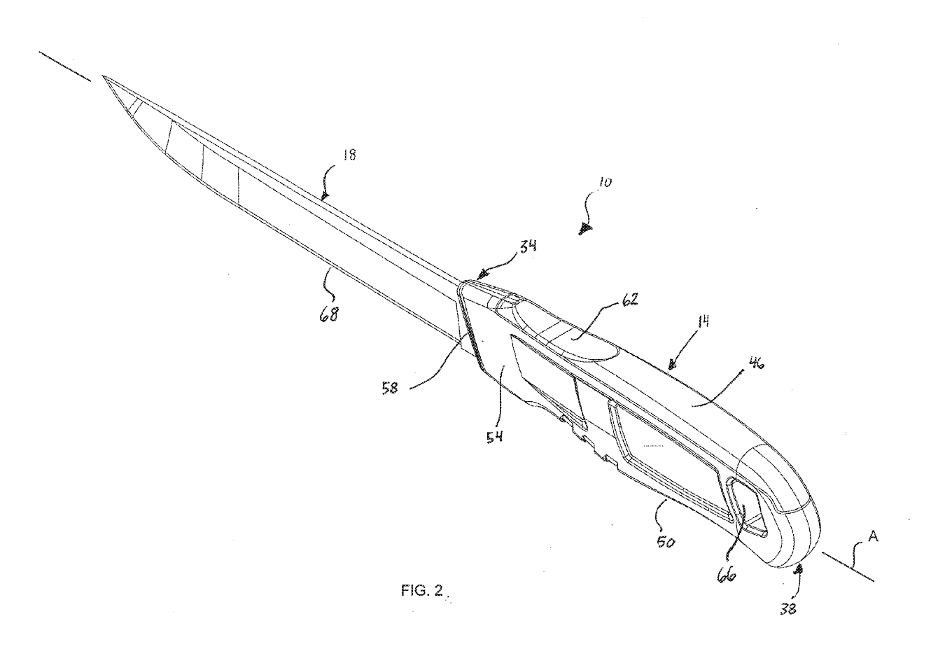

FIGS. 1-2 illustrate a knife 10 that includes a handle 14, a blade 18, and a guard 22. The knife 10 has a longitudinal axis A. The handle 14, the blade 18, and the guard 22 generally extend along the longitudinal axis A. The blade 18 is fixed to the handle 14. The guard 22 is removably coupled over the blade 18 to the handle 14.

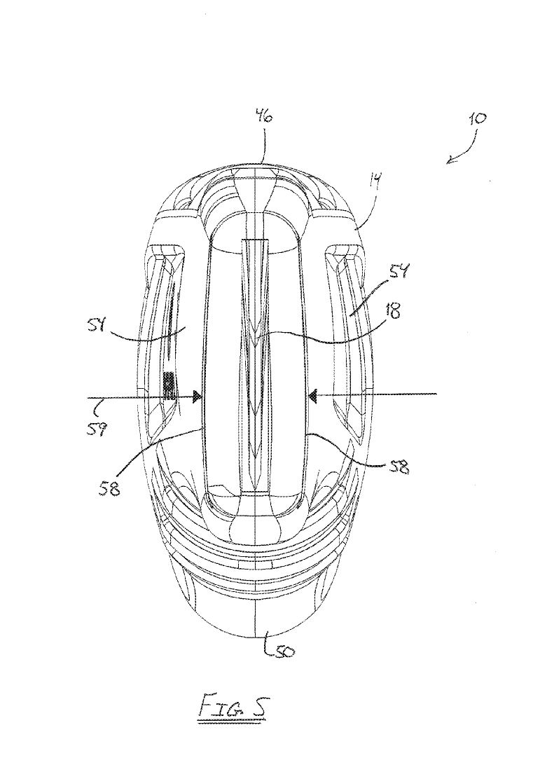

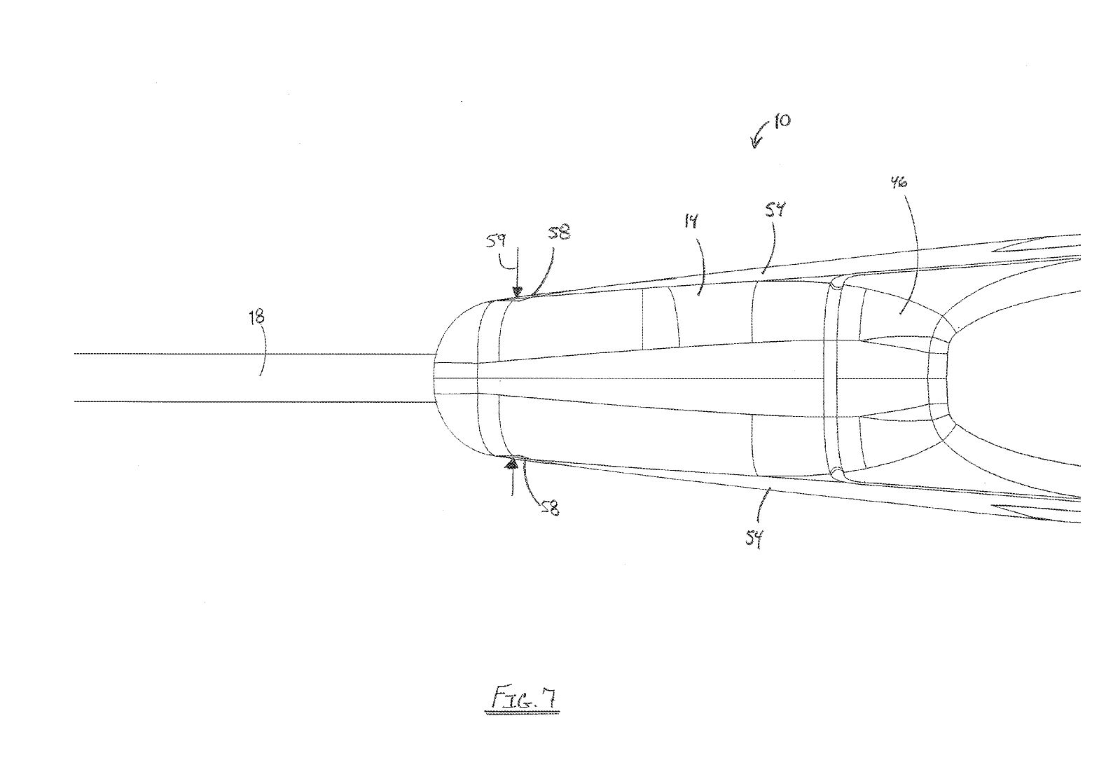

The handle 14 extends along the longitudinal axis A from a front end 34 to a back end 38 of the handle 14. The longitudinal axis A extends centrally through the handle 14 through the front end 34 and the back end 38. The handle 14 has a top wall 46, a bottom wall 50, and a pair of side walls 54 that extend from the top wall 46 to the bottom wall 50. The bottom wall 50 is formed to contour to the fingers of a user when the handle 14 is grasped. The top wall 46 defines a contoured recess 62 in which the thumb of the user may be placed when the handle 14 is grasped. The handle 14 defines an aperture 66 adjacent the back end 38 that extends through the side walls 54 transverse to the longitudinal axis A. The aperture 66 is sized to allow a lanyard, a clip, or the like, to be attached to the handle 14, such that the knife 10 may be suspended from the aperture 66. Additionally, as shown in FIGS. 2-4, a pair of detents 58 are defined by the side walls 54 of the handle 14 adjacent the front end 34 of the handle 14. In the illustrated embodiment, the detents 58 are recesses or grooves. In other embodiments, the detents 58 could include ribs or projections. The detent grooves 58 extend from the top wall 46 toward the bottom wall 50, somewhat transverse to the longitudinal axis A, on each of the side walls 54. A handle width is defined as a distance 59 (FIGS. 5 and 7) between the detents 58 normal to the longitudinal axis A.

As shown in FIG. 2, the blade 18 includes a sharp edge 68 and a tang (not shown). The tang is enclosed by the walls 46, 50, 54 of the handle 14 to fix the blade 18 relative to the handle 14. The blade 18 extends outwardly from the front end 34 of the handle 14 along the longitudinal axis A. In the illustrated embodiment, the sharp edge 68 of the blade 18 is a straight sharp edge. However, in alternate embodiments, the sharp edge 68 may be a serrated sharp edge. Additionally, the blade 18 may be made from stainless steel, titanium, or any other hard metal, alloy, or ceramic.

The guard 22 has a first, proximal end 70 and a second distal end 74. The first end 70 of the guard 22 defines an aperture 78 that receives the blade 18. The guard 22 includes a top wall 82, a bottom wall 86, and a pair of side walls 90 that extend from the top wall 82 of the guard 22 to the bottom wall 86 of the guard 22. The top wall 82, the bottom wall 86, and the side walls 90 define an interior configured to securely encompass the blade 18 when the blade 18 is fully received within the aperture 78 of the guard 22. The top wall 82, the bottom wall 86, and the side walls 90 terminate to a point at the second end 74 of the guard 22. Although, the walls 82, 86, 90 of the guard 22 are configured to define the interior with dimensions corresponding to that of the blade 18, the walls 82, 86, 90 of the guard 22 may be configured to define an interior to fit a blade 18 of any size or shape.

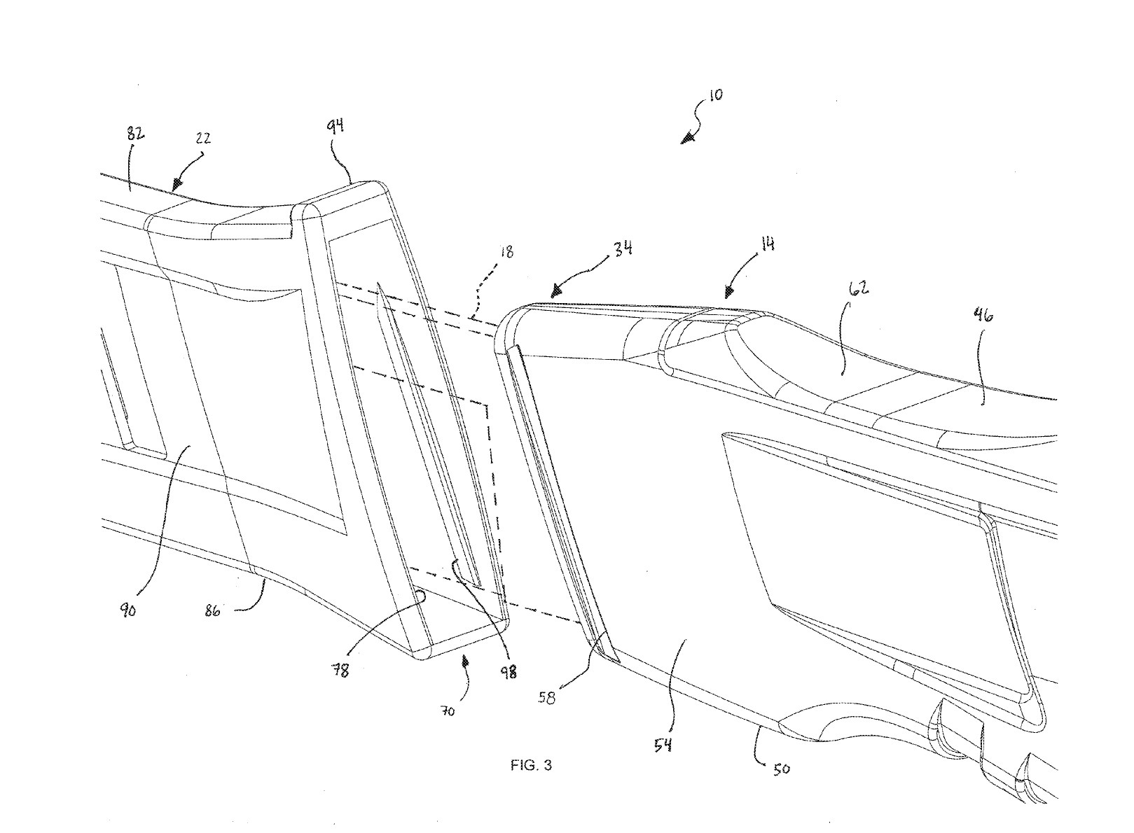

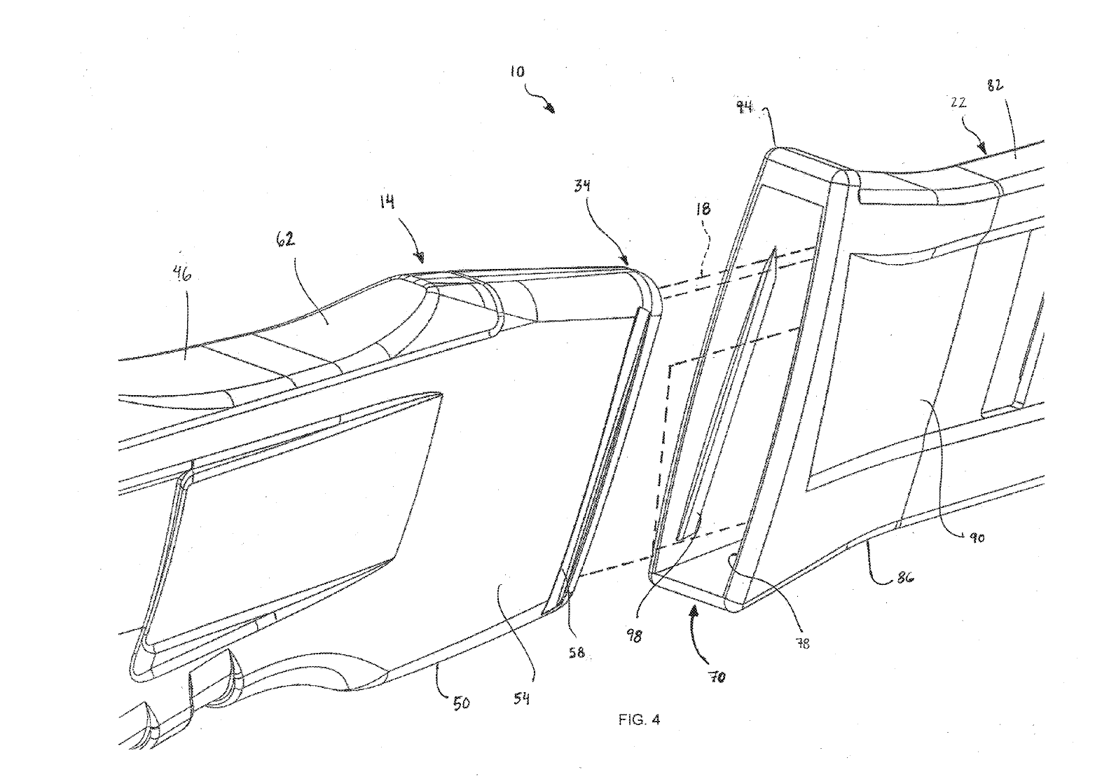

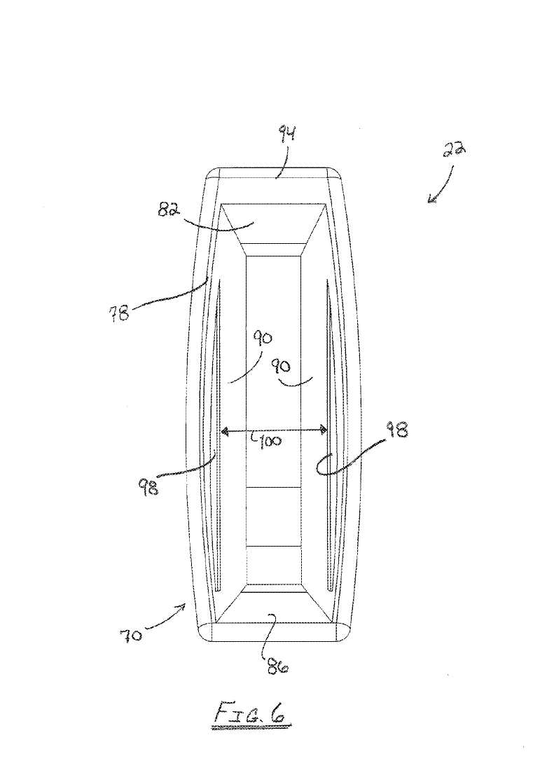

With reference to FIGS. 3-4, the guard 22 includes a flange 94 located at the first end 70 of the guard 22 adjacent the aperture 78. In the illustrated embodiment, the flange 94 extends generally perpendicularly outward from the top wall 82 of the guard 22. Although, the flange 94 may also extend partially or entirely from one or both of the side walls 90 of the guard 22. The guard 22 further includes a pair of detents 98 located on the side walls 90 inside the guard at the first end 70 of the guard 22 adjacent the aperture 78. In the illustrated embodiment, the detents 98 are ribs that project from the side walls 90. In other embodiments, for example if the detents of the handle are ribs, the detents of the guard may include recesses. The illustrated ribs 98 extend from adjacent the top wall 82 to adjacent the bottom wall 86 of the guard 22 and are generally parallel to the aperture 78 of the guard 22. A guard width is defined as the distance 100 (FIG. 6) between the detents 98 normal to the longitudinal axis A when the elastic material of the guard 22 is in an undeflected position. As will be discussed in more detail below, the elastic material of the guard 22 allows the guard 22, particularly the side walls 90 to flex as the guard 22 is being attached to the handle 14.

The detent grooves 58 of the handle 14 receive the detent ribs 98 of the guard 22 when the blade 18 is fully received within the guard 22. The guard 22 is formed from a flexible elastic material (e.g., plastic, metal, etc.), thus allowing the detent ribs 98 and the side walls 90 to bend and be deflected from an undeflected position. The guard 22 and the handle 14 are movable relative to each another between a first position and a second position. In the first position the blade 18 is fully received within the guard 22 and the detent ribs 98 engage the detent grooves 58 to secure the guard 22 over the blade 18 to the handle 14 (as shown in FIG. 1). In the second position the detent ribs 98 are removed from the detent grooves 58 of the handle 14 (as shown in FIGS. 3-4). In the second position the guard 22 may be slid on the blade 18 away from the handle 14 along the longitudinal axis A until the blade 18 is fully removed from the guard 22.

Although, in the illustrated embodiment the detent ribs 98 are formed by the guard 22, and the detent grooves 58 are defined by the handle 14, in alternate embodiments the detent ribs 98 may be formed on the handle 14 and the detent grooves 58 may be defined by the guard 22. In further alternate embodiments, one of detent grooves 58 of the handle 14 may be exchanged with the corresponding detent rib 98 of the guard 22. Although only a single pair of detent ribs 98 and a corresponding pair of detent grooves 58 are shown, in alternate embodiments any number of detent ribs 98 and detent grooves 58 may be used. In yet further alternate embodiments, the detent ribs 98 and the detent grooves 58 may be any corresponding shapes.

To secure the guard 22 over the blade 18 to the handle 14 in the first position, the user needs only to insert the blade 18 into the aperture 78 of the guard 22 and slide the first end 70 of the guard 22 toward the front end 34 of the handle 14 along the longitudinal axis A. As the guard 22 is moved to the first position, the first end 70 of the handle 14 is received by the aperture 78 of the guard 22. The distance 59 between each of the side walls 54 at the front end 34 of the handle 14 is wider than the distance 100 between the detent ribs 98 in the undeflected position, therefore forcing the side walls 90 of the guard 22 to bend outwardly, deflecting the side walls 90 and the detent ribs 98 away from the longitudinal axis A. Once the detent ribs 98 are aligned with, and positioned over, the detent grooves 58, due to the flexible spring-like characteristics of the side walls 90 of the guard 22, the detent ribs 98 are biased into the detent grooves 58 as the detent ribs 98 and the side walls 90 of the guard 22 spring back to the undeflected position, effectively functioning as a snap fit connection, providing a tactile indication to the user that the guard 22 is secured to the handle 14. Due to the biasing force the detent ribs 98 are retained in the detent grooves 58 to secure the guard 22 to the handle 14. Consequently, the guard 22 is not inadvertently removed from the handle 14, for example by gravity, while the knife 10 is suspended by a lanyard or clip from the aperture 66. Therefore, the sharp edge 68 of the blade 18 is inhibited from being unintentionally exposed.

To remove the guard 22 from the blade 18 of the knife 10 when the guard is coupled to the handle 14, the user first grasps the handle 14 within their hand so that their thumb is adjacent the flange 94. The user then applies a force to the flange 94, using the thumb of the same hand gripping the handle 14, in a direction F along the longitudinal axis A (FIG. 1). Simply put, the user may hold the knife 10 and apply a force to the flange 94 to remove the guard 22 with one hand (i.e., removing the guard 22 only requires a single hand). As the force is applied, the side walls 90 of the guard 22 are deflected outwardly as the detent ribs 98 are urged out of the detent grooves 58 toward the second position (FIG. 3). Once the front end 34 of the handle 14 is removed from the aperture 78 of the guard 22 the side walls 90 of the guard 22 spring back to their undeflected positions. The guard 22 may then be slid off the blade 18 away from the handle 14 along the longitudinal axis A until the guard 22 is fully removed. Once the guard 22 is removed from the blade 18, the user may use the knife 10 to cut a workpiece (e.g., insulation).

Although the invention has been described in detail with reference to certain preferred embodiments, variations and modifications exist within the scope and spirit of one or more independent aspects of the invention as described.

1. A knife comprising:
a handle including a top wall, a bottom wall, a first side wall that extends from the top wall to the bottom wall, a second side wall that extends from the top wall to the bottom wall opposite the first side wall, a front end, a back end opposite the front end, a longitudinal axis that extends centrally through the handle through the front end and the back end, a first detent on the first sidewall adjacent the front end, and a second detent on the second sidewall adjacent the front end;
a blade that extends from the front end of the handle along the longitudinal axis;
a guard formed from a flexible elastic material, the guard including a top wall, a bottom wall, a first side wall that extends from the top wall to the bottom wall, a second side wall that extends from the top wall to the bottom wall opposite the first side wall, a first end, a second end, an aperture at the first end of the guard, a first detent inside the guard on the first side wall adjacent the aperture, and a second detent inside the guard on the second sidewall adjacent the aperture,
wherein a guard width is defined as a distance between the first and second detents of the guard normal to the longitudinal axis,
wherein a handle width is defined as a distance between the first and second detents of the handle normal to the longitudinal axis,
wherein the handle width is greater than the guard width when the guard is not attached to the handle, and
wherein the first detent of the handle engages the first detent of the guard and the second detent of the handle engages the second detent of the guard to removably couple the handle and the guard.

2. The knife of claim 1, wherein the guard width is further defined as the distance between the first and second detents of the guard normal to the longitudinal axis when the flexible elastic material of the guard is in an undeflected position.

3. The knife of claim 1, wherein the first and second detents of the guard each include a rib.

4. The knife of claim 2, wherein the first and second detents of the handle each include a recess.

5. The knife of claim 1, wherein the first and second detents of the guard each include a recess.

6. The knife of claim 5, wherein the first and second detents of the handle each include a rib. The knife of claim 1, wherein the flexible elastic material of the guard includes plastic.

8. The knife of claim 1, wherein the guard includes a flange on the top wall of the guard adjacent the aperture of the guard.

9. The knife of claim 1, wherein the handle includes an aperture that extends through the first and second sidewalls of the handle adjacent the back end of the handle.

10. The knife of claim 1, wherein the blade is fixed from movement relative to the handle.

11. A knife comprising:
a handle including a first side wall, a second side wall opposite the first side wall, a front end, a back end opposite the front end, a longitudinal axis that extends centrally through the handle through the front end and the back end, a first detent on the first sidewall, and a second detent on the second sidewall;
a blade that extends from the handle;
a guard formed from a flexible elastic material, the guard including a first side wall, a second side wall, a first end, a second end, an aperture at the first end of the guard, a first detent inside the guard on the first side wall adjacent the aperture, a second detent inside the guard on the second sidewall adjacent the aperture,
wherein the first detent of the handle engages the first detent of the guard and the second detent of the handle engages the second detent of the guard to removably couple the handle and the guard,
wherein a guard width is defined as a distance between the first and second detents of the guard normal to the longitudinal axis, and
wherein the flexible elastic material of the guard allows the distance to increase while the guard is being coupled to the handle with the first detent of the handle engaging the first detent of the guard and the second detent of the handle engaging the second detent of the guard.

12. The knife of claim 11, wherein a handle width is defined as a distance between the first and second detents of the handle normal to the longitudinal axis, and wherein the handle width is greater than the guard width when the guard is not attached to the handle.

13. The knife of claim 11, wherein the guard width is further defined as the distance between the first and second detents of the guard normal to the longitudinal axis when the flexible elastic material of the guard is in an undeflected position.

14. The knife of claim 11, wherein the first and second detents of the guard each include a rib, and wherein the first and second detents of the handle each include a recess.

15. The knife of claim 11, wherein the first and second detents of the guard each include a recess, and wherein the first and second detents of the handle each include a rib.

16. The knife of claim 11, wherein the flexible elastic material of the guard includes plastic.

17. A knife comprising:
a handle including a top wall, a bottom wall, a first side wall that extends from the top wall to the bottom wall, a second side wall that extends from the top wall to the bottom wall opposite the first side wall, a front end, a back end opposite the front end, a longitudinal axis that extends centrally through the handle through the front end and the back end, a first detent on the first sidewall adjacent the front end, and a second detent on the second sidewall adjacent the front end;
a blade that extends from the front end of the handle along the longitudinal axis;
a guard including a top wall, a bottom wall, a first side wall that extends from the top wall to the bottom wall, a second side wall that extends from the top wall to the bottom wall opposite the first side wall, a first end, a second end, an aperture at the first end of the guard, a first detent inside the guard on the first side wall adjacent the aperture, and a second detent inside the guard on the second sidewall adjacent the aperture,
wherein the first detent of the handle engages the first detent of the guard and the second detent of the handle engages the second detent of the guard to removably couple the handle and the guard.

18. The knife of claim 17, wherein the first and second detents of the guard each include a rib, and wherein the first and second detents of the handle each include a recess.

19. The knife of claim 17, wherein the first and second detents of the guard each include a recess, and wherein the first and second detents of the handle each include a rib.

20. The knife of claim 17, wherein the guard includes a flange on the top wall of the guard adjacent the aperture of the guard.
